(19) United States
(12) Patent Application Publication
(10) Pub. No.: US 2014/0152882 A1
(43) Pub. Date: Jun. 5, 2014

(54) MOBILE DEVICE HAVING OBJECT-IDENTIFICATION INTERFACE

(71) Applicant: HAND HELD PRODUCTS, INC., Fort Mill, SC (US)

(72) Inventors: Justin Samek, Mt. Laurel, NJ (US); Taylor Smith, Charlotte, NC (US)

(73) Assignee: HAND HELD PRODUCTS, INC., Fort Mill, SC (US)

(21) Appl. No.: 13/780,356

(22) Filed: Feb. 28, 2013

Related U.S. Application Data
(60) Provisional application No. 61/733,007, filed on Dec. 4, 2012.

(51) Int. Cl. H04N 5/232

(52) U.S. Cl. CPC H04N 5/23293
USPC 348/333.02

(57) ABSTRACT

A mobile device includes a camera, a user interface system, and a processor communicatively coupled to the camera and the user interface system. The user interface system includes a visual display. The processor is configured for (i) capturing an image with the camera, (ii) extracting the identity of an object in the image, and (iii) searching for information relating to the object in a database. The processor is further configured for concurrently displaying (i) at least a portion of the image in a first portion of the visual display and (ii) a data field in a second portion of the visual display, while searching for information relating to the object. Finally, the processor is configured for populating the data field with information from the database and relating to the object.

### CROSS-REFERENCE TO PRIORITY APPLICATION

This application hereby claims the benefit of pending U.S. Provisional Patent Application No. 61/733,007 for a “Mobile Device Having Object-Identification Interface” (filed Dec. 4, 2012 at the United States Patent and Trademark Office), which is hereby incorporated by reference in its entirety.

### FIELD OF THE INVENTION

The present invention relates to the field of mobile devices, more specifically, to mobile devices having an improved object-identification interface.

### BACKGROUND

Mobile devices (e.g., smartphones and tablet computers) now typically have integrated cameras. Accordingly, numerous applications capable of utilizing an integrated camera have been developed for these mobile devices.

Applications have been developed for using a mobile device's integrated camera to perform object identification (e.g., by decoding a barcode on an object in an image) for shopping or inventory management. Using data (e.g., a decoded barcode) from an image, the application may perform a database lookup to acquire information about an identified object and, thereafter, provide the acquired information to a user.

The interface in current applications makes it difficult for users to discern which object was identified, particularly during the database lookup step. Accordingly, a need exists for an improved object-identification interface.

### SUMMARY

Accordingly, in one aspect, the present invention embraces a mobile device that includes a camera, a user interface system, and a processor communicatively coupled to the camera and the user interface system. The user interface system includes a visual display. The processor is configured for (i) capturing an image with the camera, (ii) extracting the identity of an object in the image, and (iii) searching for information (e.g., retrieving information) relating to the object in a database in communication with the processor. The processor is further configured for concurrently displaying (i) at least a portion of the image (e.g., a portion of the image containing the identified object) in a first portion of the visual display and (ii) a data field in a second portion of the visual display, while searching for information relating to the object. Finally, the processor is configured for populating the data field with information from the database and relating to the object.

In one exemplary embodiment, populating the data field includes concurrently displaying (i) the portion of the image in the first portion of the visual display and (ii) information relating to the object in the data field in the second portion of the visual display.

In another exemplary embodiment, at least a portion of the image that includes the object is displayed. Furthermore, the processor is configured for displaying an identifier overlaying at least a portion of the object in the portion of the image displayed in the first portion of the visual display.

In another aspect, the present invention embraces a method of identifying an object with a mobile device. First, a mobile device having a camera, a visual display, and a processor communicatively coupled to the camera and the visual display is provided. Next, an image is captured with the camera. The identity of an object in the image is extracted. Once the identity of the object has been extracted, information relating to the object is searched for in a database that is in communication with the processor. While searching for information relating to the object, at least a portion of the image and a data field are concurrently displayed on the visual display. In this regard, at least a portion of the image is displayed in a first portion of the visual display and the data field is displayed in a second portion of the visual display. Finally, the data field is populated with information from the database and relating to the object.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 depicts a block diagram of a mobile device in accordance with the present invention.

FIG. 2 depicts a block diagram of a mobile device in accordance with an alternative embodiment of the present invention.

FIG. 3 depicts a mobile-device visual display concurrently displaying (i) an image of an object and (ii) a data field.

FIG. 4 depicts a mobile-device visual display displaying a data field populated with information about an identified object.

FIG. 5 depicts a mobile-device visual display displaying (i) an image of more than one object and (ii) a data field.

### DETAILED DESCRIPTION

The present invention embraces a mobile device (e.g., a cellular phone, a smartphone, a personal digital assistant, a portable or mobile computer, and/or a tablet device) having an improved object-identification interface. The mobile device includes a camera and a visual display communicatively coupled to a processor. The processor is configured to capture an image of an object with the camera. Thereafter, the object is identified so information about the object can be looked up. The processor is further configured for concurrently displaying (i) at least a portion of the image in a first portion of the visual display and (ii) a data field in a second portion of the visual display. Information about the identified object may be displayed in the data field.

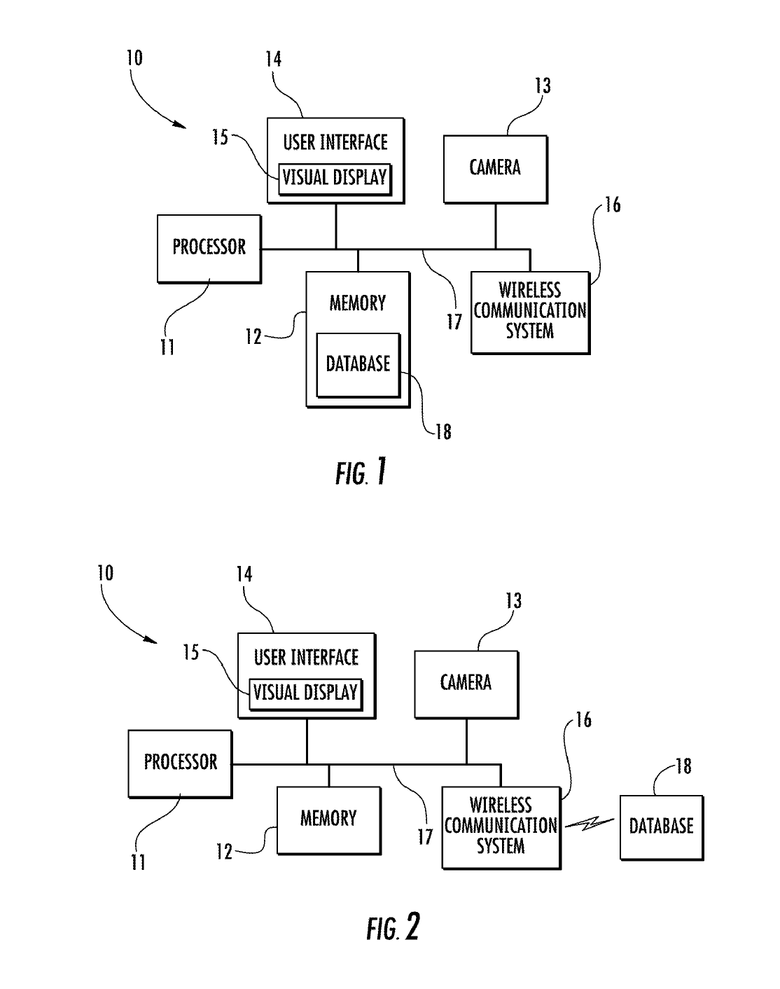

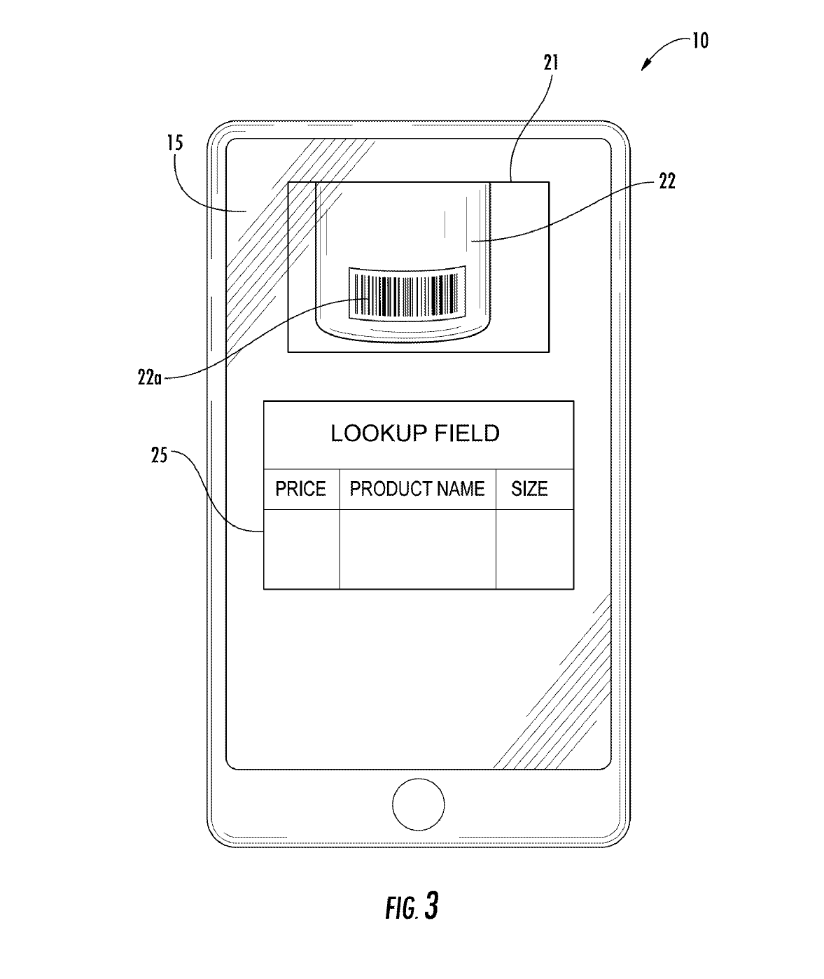

FIGS. 1-2 schematically depict an exemplary mobile device 10 in accordance with the present invention. The mobile device 10 typically includes a processor 11, a memory 12, a camera 13, a user interface 14, and a wireless communication system 16. The processor 11 is communicatively coupled to the memory 12, the camera 13, the user interface 14, and the wireless communication system 16.

Exemplary mobile devices may include a system bus 17 and/or one or more interface circuits (not shown) for coupling the processor 11 and other components to the system bus 17. In this regard, the processor 11 may be communicatively coupled to each of the other components via the system bus 17 and/or the interface circuits. Similarly, the other components (e.g., the memory 12, the camera 13, the user interface 14, and the wireless communication system 16) may each be communicatively coupled to other components via the system bus 17 and/or the interface circuits. Other embodiments of system bus architecture providing for efficient data transfer and/or communication between the components of the device may be also be employed in exemplary embodiments in accordance with the present invention.

Typically, the processor 11 is configured to execute instructions and to carry out operations associated with the mobile device 10. For example, using instructions retrieved from the memory 12 (e.g., a memory block), the processor 11 may control the reception and manipulation of input and output data between components of the mobile device 10. The processor 11 typically operates with an operating system to execute computer code and produce and use data. The operating system, other computer code, and data may reside within the memory 12 that is operatively coupled to the processor 11. The memory 12 generally provides a place to store computer code and data that are used by the mobile device 10. The memory 12 may include Read-Only Memory (ROM), Random-Access Memory (RAM), a hard disk drive, and/or other non-transitory storage media. The operating system, other computer code, and data may also reside on a removable non-transitory storage medium that is loaded or installed onto the mobile device 10 when needed. Exemplary removable non-transitory storage media include CD ROM, PC-CARD, memory card, floppy disk, and/or magnetic tape.

The user interface 14 includes one or more components capable of interacting with a user (e.g., receiving information from a user or outputting information to a user). As depicted in FIG. 1, the user interface 14 includes a visual display 15. Typically, the visual display 15 is a touch screen, which is capable of displaying visual information and receiving tactile commands from a user. In addition to the visual display 15, the user interface 14 may also include one or more speakers, buttons, keyboards, and/or microphones.

As noted, the mobile device 10 typically includes a wireless communication system 16. The wireless communication system 16 enables the mobile device 10 to communicate with a wireless network, such as a cellular network (e.g., a GSM network, a CDMA network, or an LTE network), a local area network (LAN), and/or an ad hoc network.

The camera 13 may be any device that is able to capture still photographs and/or video. Typically, the camera 13 is able to capture both still photographs and video. Although FIG. 1 depicts the mobile device 10 as having a single camera 13, it is within the scope of the present invention for the mobile device 10 to include more than one camera.

The processor 11 is typically in communication with a database 18. As depicted in FIG. 1, the database 18 may be stored within the memory 12. In an alternative embodiment depicted in FIG. 2, the processor 11 may access the database 18 via the wireless communication system 16. In other words, the processor may access the database 18 through the internet or a local area network via the wireless communication system 16.

The database 18 includes information relating to one or more objects. Typically, the database 18 includes information relevant to stock management and/or retail transactions. For example, the database 18 may include relevant information (e.g., name, price, size, associated barcode, stocking location, and/or quantity) regarding goods sold in a retail store.

The processor 11 is configured to identify an object and provide relevant information about the object to a user.

In order to identify an object, the processor 11 is configured to capture an image with the camera 13 (e.g., after receiving a user command from the user interface 14 to begin an object-identification sequence). Typically the image will contain one or objects (e.g., goods for sale in a retail store) that can be identified.

The processor 11 is configured to extract the identity of an object in the image once the image has been captured. The processor 11 may be configured to identify multiple objects in the image. That said, if the image has a plurality of identifiable images, the processor 11 may be configured to identify only one of the identifiable objects (e.g., by extracting the identity of the first identifiable object in the image).

In one embodiment, the object may be identified by decoding a barcode located on the object and contained within the image. In another embodiment, the object may be identified by using visual recognition software. In yet another embodiment, the object may be identified by scanning an RFID tag located on the object.

If no object can be identified, the processor 11 may be configured to display a message (e.g., with the visual display 15) that no object could be identified. Alternatively, the processor 11 may be configured to capture another image with the camera 13.

Once the object has been identified (e.g., by decoding a barcode), the processor 11 will look up (i.e., search for) information associated with the identified object (e.g., associated with a decoded barcode) in the database 18 (e.g., name, price, associated barcode, stocking location, and/or quantity). If multiple objects are identified, the processor 11 will typically look up information associated with each of the identified objects.

The processor 11 is configured for, while searching for information related to the identified object (e.g., in the database 18), concurrently displaying (i) at least a portion of the image in a first portion of the visual display 15 and (ii) a data field in a second portion of the visual display 15.

In this regard, FIG. 3 depicts the mobile device 10 with an image 21 (e.g., at least portion of an image taken with camera 13) being displayed in a first portion of the visual display 15. The image 21 may be identical to the image taken with the camera 13. Alternatively, the image taken with the camera 13 may be altered (e.g., cropped and/or reduced format, quality and/or size) to form the image 21. For example, the image 21 may be a thumbnail of the image taken with the camera 13. The image 21 typically includes at least a portion of an identified object 22. For example, FIG. 3 depicts the identified object 22 as being a shampoo bottle 22 having a barcode 22a. If multiple objects are identified, the image 21 may include at least a portion of each identified object.

In addition to the image 21 in the first portion of the visual display 15, FIG. 3 also depicts a data field 25 (e.g., a lookup field) for displaying information (e.g., name, price, size, associated barcode, stocking location, and/or quantity) about the identified object 22 being displayed in a second portion of the visual display 15. FIG. 3 depicts the data field 25 as being blank (i.e., not populated with information relevant to the identified object 22). As depicted in FIG. 3, the data field 25 may have one or more sub-fields (e.g., price, size, and/or product name).

Once the processor 11 has searched for information related to the identified object 22, the processor will then populate the data field 25 with relevant information retrieved from the database 18. If multiple objects are identified, the processor will typically populate the data field 25 with information relevant to each identified object.

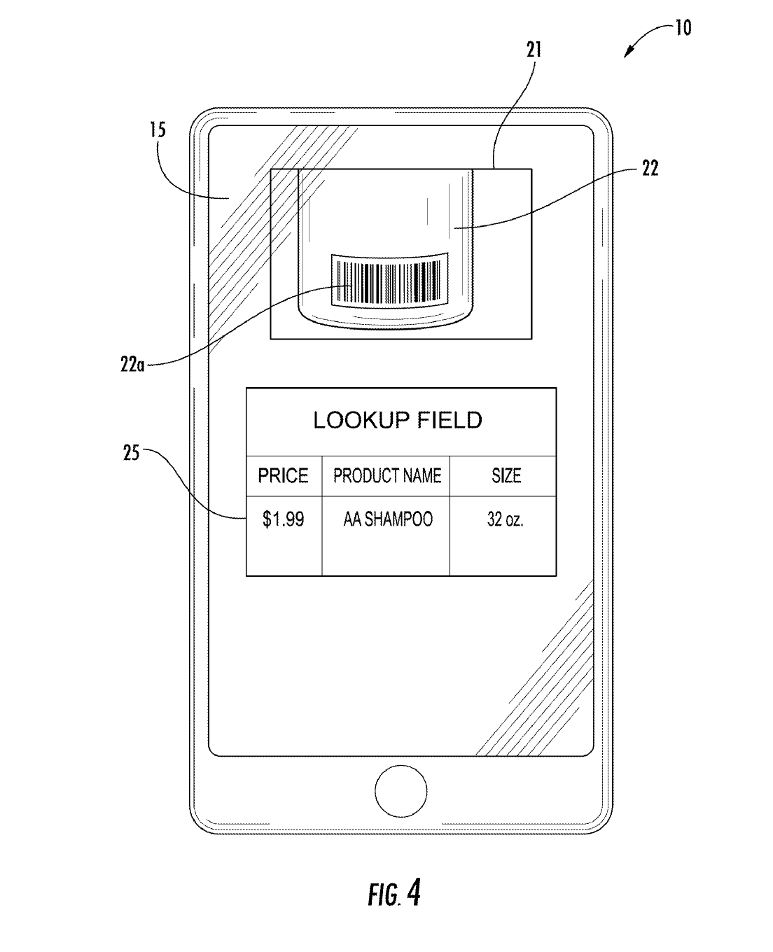

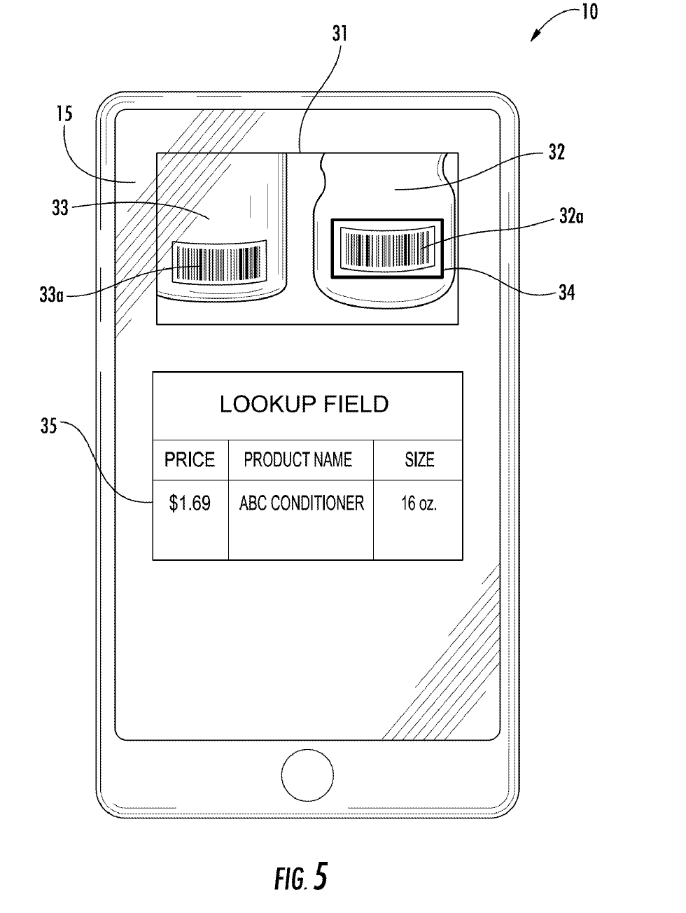

In this regard, FIG. 4 depicts the data field 25 displaying information relevant to the identified object 22. As depicted in FIG. 4, the image 21 in the first portion of the visual display 15 is typically retained (e.g., displayed) once the data field 25 has been populated. If no information could be retrieved from the database 18, the processor may populate the data field 25 with a message indicated that information could not be found.

In one embodiment, displaying the image 21 in the first portion of the visual display 15 (e.g., both while searching for information in the database 18 and after populating the data field 25) includes displaying an identifier overlaying at least a portion of the identified object. For example, the identifier may be an identifying marker superimposed upon at least a portion of the identified object. By way of further example, the identifier may be an outline (e.g., a colored outline) around at least a portion of the identified object. If a captured image includes a plurality of identifiable objects, displaying an identifier overlaying the identified object informs the user exactly which object was identified.

If multiple objects are identified, multiple identifiers may be displayed, each overlaying at least a portion of one of the identified objects. Each identifier is typically unique (i.e., different from other displayed identifiers). For example, each identifier may be a differently colored outline. Information may be displayed in the data field 25 to associate each unique identifier with its relevant information (i.e., displayed information relevant to the identifier's object). For example, the color of each unique identifier may be displayed adjacent to relevant information displayed in the data field 25.

By way of example, FIG. 5 depicts an image 31 being displayed in the first portion of the visual display 15. The image 31 includes an identified object 32 having a barcode 32a and an unidentified object 33 having a barcode 33a. An identifier 34 (e.g., an outline 34 surrounding the barcode 32a) overlays the identified object 32. A data field 35 is displayed in a second portion of the visual display 15. Although FIG. 5 depicts the data field 35 as being populated (e.g., displaying information relevant to the identified object 32), it is within the scope of the present invention to display the identifier 34 overlaying at least a portion of the identified object 32 while searching in the database 18 for information regarding the identified object 32 (i.e., while the data field 35 is not populated).

It is within the scope of the present invention for the foregoing steps, namely (i) capturing an image, (ii) identifying an object in the image, (iii) searching for information (e.g., retrieving information) regarding the identified object, (iv) displaying a data field and at least a portion of the image, and (v) populating the data field with information regarding the identified object, to be interrupted by another process on the mobile device 10. For example, these steps may be interrupted if the mobile device 10 receives a phone call. During the interruption, these steps may be paused or continued in the background of the mobile device 10. Once the interruption has concluded (e.g., the call has ended), these steps may be resumed and/or returned to the foreground of the mobile device 10.

Once the data field has been populated, the foregoing steps, namely (i) capturing an image, (ii) identifying an object in the image, (iii) searching for information (e.g., retrieving information) regarding the identified object, (iv) displaying a data field and at least a portion of the image, and (v) populating the data field with information regarding the identified object, may be repeated (e.g., to identify another object). Alternatively, this process may be terminated (e.g., upon the receipt of a user command to terminate).

The present invention provides an improved object-identification interface. In contrast, with prior object-identification applications, the present object-identification interface concurrently displays (i) an image of an identified object and (ii) a data field for displaying information regarding the identified object. By concurrently displaying (i) an image of an identified object and (ii) a data field for displaying information regarding the identified object, a user does not have to worry about remembering what object was identified.

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A mobile device, comprising:
a camera;
a user interface system, the user interface system comprising a visual display; and
a processor communicatively coupled to the camera and the user interface system, the processor being configured for:
capturing an image with the camera;
extracting the identity of an object in the image;
searching for information relating to the object in a database in communication with the processor;
while searching for information relating to the object, concurrently displaying (i) at least a portion of the image in a first portion of the visual display and (ii) a data field in a second portion of the visual display; and
populating the data field with information from the database and relating to the object.

2. The mobile device according to claim 1, wherein populating the data field comprises concurrently displaying (i) the portion of the image in the first portion of the visual display and (ii) information relating to the object in the data field in the second portion of the visual display.

3. The mobile device according to claim 2, wherein displaying the portion of the image in the first portion of the visual display comprises displaying a portion of the image that includes the object.

4. The mobile device according to claim 3, wherein the processor is configured for displaying an identifier overlaying at least a portion of the object in the portion of the image displayed in the first portion of the visual display.

5. The mobile device according to claim 4, wherein capturing the image comprises capturing an image containing a plurality of objects.

6. The mobile device according to claim 4, wherein capturing the image comprises capturing an image containing a barcode on the object.

7. The mobile device according to claim 6, wherein extracting the identity of the object comprises decoding the barcode.

8. The mobile device according to claim 7, wherein displaying the portion of the image in the first portion of the visual display comprises displaying a portion of the image that includes the barcode and displaying an identifier overlaying the barcode in the portion of the image displayed in the first portion of the visual display.

9. The mobile device according to claim 8, wherein displaying an identifier overlaying the barcode comprises displaying an outline surrounding the barcode in the portion of the image displayed in the first portion of the visual display.

10. The mobile device according to claim 4, comprising:
a non-transitory computer-readable storage medium; and
the database, the database being stored on the non-transitory computer-readable storage medium.

11. The device according to claim 4, wherein:
the mobile device does not comprise the database; and
the mobile device comprises a wireless communication system communicatively coupled to the processor, the wireless communication system being in communication with the database.

12. The method of identifying an object with a mobile device, comprising:
providing a mobile device having a camera, a visual display, and a processor communicatively coupled to the camera and the visual display;
capturing an image with the camera;
extracting the identity of an object in the image;
searching for information relating to the object in a database in communication with the processor;
while searching for information relating to the object, concurrently displaying (i) at least a portion of the image in a first portion of the visual display and (ii) a data field in a second portion of the visual display; and
populating the data field with information from the database and relating to the object.

13. The method according to claim 12, wherein the step of populating the data field comprises concurrently displaying (i) the portion of the image in the first portion of the visual display and (ii) information relating to the object in the data field in the second portion of the visual display.

14. The method according to claim 13, wherein the steps of displaying the portion of the image in the first portion of the visual display each comprise displaying a portion of the image that includes the object.

15. The method according to claim 14, wherein the steps of displaying the portion of the image in the first portion of the visual display each comprise displaying an identifier overlaying the object in the portion of the image displayed in the first portion of the visual display.

16. The method according to claim 15, wherein the step of capturing the image comprises capturing an image containing a plurality of objects.

17. The method according to claim 15, wherein the step of capturing the image comprises capturing an image containing a barcode on the object.

18. The method according to claim 17, wherein the step of extracting the identity of the object in the image comprises decoding the barcode.

19. The method according to claim 18, wherein the steps of displaying the portion of the image in the first portion of the visual display each comprise displaying a portion of the image that includes the barcode and displaying an identifier overlaying the barcode in the portion of the image displayed in the first portion of the visual display.

20. The method according to claim 19, wherein displaying an identifier overlaying the barcode comprises displaying an outline surrounding the barcode in the portion of the image displayed in the first portion of the visual display.
